(19) United States
(12) Patent Application Publication
(10) Pub. No.: US 2009/0170982 A1
(43) Pub. Date: Jul. 2, 2009

(54) Process for Manufacture of Paper Coatings With Improved Water Retention and Brookfield Viscosity Using a Comb Polymer With at Least One Grafted Polyalkylene Oxide Function

(76) Inventors: Francois Dupont, Lyon (FR); Jean-Marc Suau, Lucenay (FR)

Correspondence Address: AMSTER, ROTHSTEIN & EBENSTEIN LLP, 90 PARK AVENUE, NEW YORK, NY, 10016, US

(21) Appl. No.: 12/085,280

(22) PCT Filed: Dec. 6, 2006
(86) PCT No.: PCT/IB2006/003575

§ 371 Date: May 20, 2008

(30) Foreign Application Priority Data
Dec. 16, 2005 (FR) 05/12797

(51) Int. Cl. C08K 3/26; D21H 19/58; C08L 51/00

(52) U.S. Cl. 524/52; 524/543; 524/425; 524/504; 524/556; 524/555

(57) ABSTRACT

The invention concerns a process to manufacture paper coatings containing at least one mineral matter, at least one binder and water, characterised in that at least one comb polymer obtained by grafting of a least one polyalkylene oxide function on to the polymer chain, where the said chain results from the polymerisation of a least one ethylenic unsaturated monomer, is introduced into the above-mentioned composition.

The paper coatings thus obtained have increased water retention and reduced Brookfield viscosity compared to the same coatings containing a water-retaining thickening agent of the prior art.

The present invention concerns the technical sector of paper coatings used in the manufacture of papers and cartons coated using the said coatings, and more specifically the field of water retention agents and rheology modifying agents used in the composition of the said coatings.

In the manufacture of paper sheets by coating, an aqueous composition called the “paper coating” is deposited on the surface of the support paper, which notably contains water, one or more mineral fillers, one or more binders and miscellaneous additives.

After being deposited on the support, the paper coating has a natural tendency to transfer into the support all or part of the water and of the water-soluble substances it contains. The goal of the skilled man in the art who is a formulator of such paper coatings is then to reduce as far as possible this migration of the water and of the water-soluble substances, with a view to preventing a change of the rheology of the paper coating which is unused and recycled in the coating process. The phenomenon of “water retention” is then spoken of, which it is sought to improve, i.e. to increase. Water-retaining agents are used for this purpose.

It is well known to use as water-retaining agents of paper coatings, starch, polyvinylic alcohol (PVOH), carboxymethylcellulose (CMC)-based polymers, and latex or highly carboxylated polymer emulsions, or again polycarboxylates such as polyacrylates, or lastly the particular class of alkali inflatable polymers.

Such products, and their use as agents allowing the water retention of paper coatings, are notably described in document EP 0 509 878, as an object of the invention in respect of a blend of inflating alkali polymers and inflating non-alkali polymers, and as the state of the technique for the other polymers mentioned above. The Applicant indicates that these agents, in addition to affecting the water retention of paper coatings, also act as a thickening agents; as such, the skilled man in the art designates them with the expression “water-retaining thickening agents”.

However, there is a second very important datensatz requirement for the formulator of paper coatings, which lies in obtaining a low Brookfield™ viscosity for the said coating, in order to obtain a product which is easily handleable by the end user. Unfortunately for the skilled man in the art, none of the above-mentioned compositions enables water retention to be improved constantly, while retaining a sufficiently low Brookfield™ viscosity of the paper coating. Thus, it is notably well known that the above-mentioned products of the prior art, in addition to the advantageous properties which they give the paper coatings in terms of water retention, have a limited application due to the high Brookfield™ viscosities which they develop in these same coatings.

The skilled man in the art is thus faced with the problem of optimising the water retention and the Brookfield™ viscosity of the paper coating, which may be summarised through the following twin problem of obtaining an improved water retention/Brookfield™ viscosity pair, i.e. obtaining:
for a given Brookfield™ viscosity, a better (higher) water retention than with the use of a water-retaining thickening agent of the prior art in the paper coating;
or for a given water retention, a better (lower) Brookfield™ viscosity than with the use of a water-retaining thickening agent of the prior art in the paper coating.

Currently, the skilled man in the art is familiar, with a view to resolving this problem, only with document EP 1 203 121, which describes the use for the manufacture of paper coatings of water-soluble copolymers in a neutral or alkaline medium and consisting of an acrylic monomer and a vinylic monomer having a glass transition temperature greater than 90° C., such as notably styrene and styrenic derivatives.

These copolymers enable the water retention of the paper coating to be improved and the Brookfield™ viscosity to be regulated, either at a higher value, or at a lower value.

However, this solution is restrictive for the skilled man in the art, since these polymers, which take the form of acidic emulsions, belong to the above-mentioned alkali polymers, which must be neutralised to fulfil their thickening and water retaining function. And this neutralisation constitutes an additional step in use of the paper coating: it is thus a loss of time but also of money through the use of neutralisation agents.

Thus, to resolve the problem of optimising the water retention and the Brookfield™ viscosity of the paper coating, which may be summarised through the following twin problem of obtaining an improved water retention/Brookfield™ viscosity pair, i.e. obtaining:
for a given Brookfield™ viscosity, a better (higher) water retention than with the use of a water-retaining thickening agent of the prior art in the paper coating,
or for a given water retention, a better (lower) Brookfield™ viscosity than with the use of a water-retaining thickening agent of the prior art in the paper coating,
   the Applicant has developed a new process for manufacturing paper coatings, containing:
(a) at least one mineral matter,
(b) at least one binder,
(c) water,
   and characterised in that at least one comb polymer, obtained by grafting at least one polyalkylene oxide function on to the polymer chain, where the said chain results from polymerisation of at least one ethylenic unsaturated monomer, is introduced into the above-mentioned composition.

The said process leads, in a completely surprising manner, to paper coatings being obtained which have a water retention/Brookfield™ viscosity pair which is substantially improved (this improvement is explained above) compared to paper coatings containing, in place of the above-mentioned comb polymer, a water-retaining thickening agent of the prior art.

Finally, the Applicant wishes to indicate a number of documents which describe the use of polymers of the comb type, obtained by grafting of at least one polyalkylene oxide function on to the polymer chain. These uses, as the Applicant will describe below, take place in applications often far removed from that of the paper field, and in all cases in order to resolve technical problems different from that forming the subject of the present application.

Thus, the Applicant can cite document EP 0 610 534, which teaches the preparation of polymers obtained by copolymerisation of an isocynate monomer and aprotic monomers, followed by functionalisation by means of monoalkylated amines or ethers of glycol polyalkylenes. Such agents are particularly effective for the grinding of organic pigments, which is a field which is completely different from that forming the subject of the present application.

Similarly, they indicate that document WO 00/077 058 describes polymers based on an unsaturated derivative of a mono- or dicarboxylic acid, on an unsaturated derivative of glycol polyalkylene, on an unsaturated polysiloxane composition or on an unsaturated ester. These copolymers are used as dispersing agents in aqueous suspensions of mineral fillers, notably in the cements sector, which is a field very far removed from the paper sector.

They are also aware of document WO 2004/041 882, which describes an ionic, water-soluble copolymer having a glycol polyalkylene alkoxy or hydroxy function, the role of which is to disperse and/or aid grinding of pigments and/or mineral fillers. The said copolymer enables aqueous suspensions of this said refined matter to be obtained, with a dry matter concentration which may be high, with a low Brookfield™ viscosity which is stable over time, having the property of having a pigment surface the ionic charge of which, determined by titration, is low: this is therefore a technical problem which is very different from the one which the present invention seeks to resolve.

They are also familiar with document WO 2004/041 883, which teaches the use of a water-soluble copolymer, preferably weakly ionic and water-soluble, having at least one glycol polyalkylene alkoxy or hydroxy function grafted on to at least one ethylenic unsaturated monomer, as an agent improving the brightness of the final product such as a sheet of paper or a plastic. However, improvement of brightness is in no sense the purpose of the present invention.

Finally the Applicant is also familiar with document WO 2004/044 022, which describes the use of a water-soluble copolymer having at least one glycol polyalkylene alkoxy or hydroxy function grafted on to at least one ethylenic unsaturated monomer, as an agent improving the activation of optical brightening in the paper, textile, detergent and paint fields. In example 10 of this document, it is indicated that 2 polymers with a base of acrylic acid, methacrylic acid and methoxypolylethylene glycol methacrylate of molecular weight 2000 improve the water retention of a paper coating: this improvement is relative to a reference consisting of a paper coating not containing any water-retaining thickening agent of the prior art. And, under the present application, we find ourselves in the case of a reference already containing such a water-retaining thickening agent of the prior art, which constitutes a different technical problem. Nothing suggested to the skilled man in the art in document WO 2004/044 022 that polymers of the comb type according to the present application would lead to water retention values higher than those obtained with paper coatings containing a water-retaining thickening agent of the prior art. Finally, example 10 of this document WO 2004/044 022 indicates that the Brookfield™ viscosities of the paper coatings containing the 2 previously described polymers are “compatible with use in paper coating”. Nothing indicated or suggested the possibility of reducing the Brookfield™ viscosity of the said coating by adding a polymer of the comb type according to the present application, where this reduction is measured in comparison with the same coating containing a water-retaining thickening agent of the prior art.

Thus, a first object of the invention is therefore a process to manufacture paper coatings, where the said coatings contain:
(a) at least one mineral matter,
(b) at least one binder,
(c) water,
   characterised in that at least one comb polymer, obtained by grafting at least one polyalkylene oxide function on to the polymer chain, where the said chain results from polymerisation of at least one ethylenic unsaturated monomer, is introduced into the above-mentioned composition, as an agent enabling the water retention to be increased and the Brookfield™ viscosity of the composition to be reduced.

The process according to the invention is also characterised in that the said polymer is introduced:
1. with the mineral matter, in the form of dry powder, and/or of aqueous dispersion and/or of aqueous suspension, resulting from the stages of:
   grinding and/or dispersion in a wet medium and preferentially aqueous medium of the mineral matter in the presence of the said polymer, and possibly in the presence of at least one grinding agent by a wet method and/or of at least one dispersing agent, leading to an aqueous dispersion and/or suspension of the mineral matter being obtained;
   and in the case of the dry powder only, of drying of the aqueous dispersion and/or suspension of the mineral matter, possibly followed by processing and classification of the powder obtained;
2. and/or with the mineral matter, in the form of an aqueous dispersion and/or an aqueous suspension, resulting from the stages of:
   dry grinding of the mineral filler, possibly in the presence of at least one dry grinding agent, possibly followed by processing and classification of the powder obtained;
   aqueous dispersion and/or suspension of the powder obtained, with introduction of the said polymer and possibly in the presence of a dispersing agent;
3. and/or with the mineral matter, in the form of dry powder, and/or aqueous dispersion and/or aqueous suspension, resulting from the stages of:
   introduction of the said polymer into a dispersion and/or into an aqueous suspension containing the mineral matter;
   and in the case of the dry powder only, of drying of the aqueous dispersion and/or suspension of the mineral matter, possibly followed by processing and classification of the powder obtained;
4. and/or in the form of dry powder mixed with the other constituents a), b) and c);
5. and/or in the form of an aqueous solution mixed with the other constituents a), b) and c);

The process according to the invention is also characterised in that the paper coating:
(a) contains 3 to 20 parts, and preferentially 5 to 15 parts, by dry weight of binder, for 100 parts by dry weight of mineral matter,
(b) contains 0.1 to 2 parts, and preferentially 0.1 to 1.5 parts, by dry weight of comb polymer, for 100 parts by dry weight of mineral matter,
(c) contains water in a quantity by weight of between 20% and 80%, relative to the total weight of the paper coating.

The Applicant indicates that the skilled man in the art may then add other additives used in the habitual composition of a paper coating, such as biocides, defoaming agents, optical brighteners and optical brightener supports, without this list being, however, comprehensive.

As such, the process of manufacture of the paper coating is also characterised in that at least one water-retaining agent and/or thickening agent other than the comb polymer used may possibly be employed.

The process according to the invention is also characterised in that the mineral matter is chosen from among natural or synthetic calcium carbonate, the dolomites, kaolin, talc, gypsum, titanium oxide, satin white or aluminium trihydroxide, mica, carbon black and a blend of these fillers, such as talc-calcium carbonate blends, calcium carbonate-kaolin blends or blends of calcium carbonate with aluminium trihydroxide, or again blends with synthetic or natural fibres or again mineral co-structures such as talc-calcium carbonate or talc-titanium dioxide co-structures.

The mineral matter is preferentially a mineral filler chosen from among natural or synthetic calcium carbonate, kaolin, talc and blends of these fillers.

The mineral matter is very preferentially a mineral filler which is a natural or synthetic calcium carbonate, or their blends.

The mineral matter is extremely preferentially a natural calcium carbonate chosen from among marble, calcite, chalk, or their blends.

The process according to the invention is also characterised in that the binder is chosen from among the water-soluble binders and notably starch, or from among the synthetic latex polymer binders, such as styrene-acrylic and the styrene-butadienes or their blends, or the blends of these binders.

The process according to invention is also characterised in that the comb polymers have a molecular weight noted M_{w} of between 100,000 g/mole and 10,000,000 g/mole, and preferentially between 1,000,000 g/mole and 7,000,000 g/mole.

The Applicant indicates that in the present application the molecular weight of the polymers used is determined using the GPC (Gel Permeability Chromatography) method, using a liquid chromatography device of Waters™ brand fitted with two detectors, one of which combines dynamic diffusion of light with viscometry measured using a Viscotek™ viscometer, the other being a detector of refractometric concentration of Waters™ brand.

This liquid chromatography equipment is fitted with steric exclusion columns suitably chosen by the skilled man in the art in order to separate the different molecular weights of the polymers studied.

The elution liquid phase is an aqueous phase.

In a detailed manner, 1 ml of the polymerisation solution is sampled and placed on a capsule, and then evaporated at ambient temperature in a vacuum of less than 1 mm of mercury. The solute is diluted at 0.9% in the eluent of the GPC, and the combination is then injected in the GPC device. The eluent of the GPC is an NaHCO₃ solution: 0.08 mole/l, NaNO₃: 0.1 mole/l, triethanolamine: 0.02 mole/l, NaN₃ 0.03% by mass. The GPC column contains an isocratic pump (Waters 515) the flow rate of which is regulated at 0.5 ml/min., a kiln containing a precolumn of the “Guard Column Ultrahydrogel Waters™” type, a linear column of the “Ultrahydrogel Waters™” type measuring 30 cm in length and of 7.8 mm internal diameter, and a refractometric detector of the RI Waters™ 410 type. The kiln is heated to a temperature of 60° C. and the refractometer heated to a temperature of 50° C. The GPC device is calibrated by a series of 5 sodium polyacrylate standards supplied by Polymer Standard Service, and of polydispersity index between 1.4 and 1.7, together with a sodium polyacrylate of polydispersity index equal to 2.4 and of molecular weight equal to 5,600 g/mole.

The process according to the invention is also characterised in that the comb polymers contain at least one monomer of formula (I):

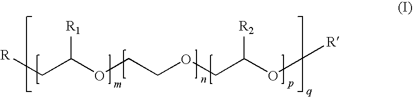

where:
m and p represent a number of alkylene oxide units of less than or equal to 150,
n represents a number of ethylene oxide units of less than or equal to 150,
q represents an integer at least equal to 1 and such that 5≦(m+n+p)q≦150,
R₁ represents hydrogen or the methyl or ethyl radical,
R₂ represents hydrogen or the methyl or ethyl radical,
R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends.

The process according to the invention is also characterised in that the comb polymers consist of:
a) of at least one anionic monomer with a carboxylic or dicarboxylic or phosphoric or phosphonic or sulphonic function, or their blends,
b) of at least one non-ionic monomer, where the non-ionic monomer consists of at least one monomer of formula (I):

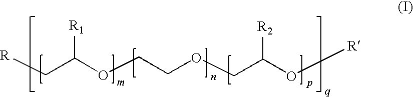

where:
   m and p represent a number of alkylene oxide units of less than or equal to 150,
   n represents a number of ethylene oxide units of less than or equal to 150,
   q represents an integer at least equal to 1 and such that 5≦(m+n+p)q≦150, and preferentially such that 15≦(m+n+p)q≦120
   R₁ represents hydrogen or the methyl or ethyl radical,
   R₂ represents hydrogen or the methyl or ethyl radical,
   R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends, and preferentially represents a hydrocarbonated radical having 1 to 12 carbon atoms, and very preferentially a hydrocarbonated radical having 1 to 4 carbon atoms.
or a blend of several monomers of formula (I),
c) possibly at least one monomer of the acrylamide or methacrylamide type, or their derivates such as N-[3-(dimethylamino) propyl] acrylamide or N-[3-(dimethylamino) propyl]methacrylamide, and their blends, or again of at least one non-water soluble monomer such as the alkyl acrylates or methacrylates, the unsaturated esters such as N-[2-(dimethylamino) ethyl]methacrylate, or N-[2-(dimethylamino) ethyl] acrylate, the vinylics such as vinyl acetate, vinylpyrrolidone, styrene, alphamethylstyrene and their derivates, or at least one cationic monomer or quaternary ammonium such as [2-(methacryloyloxy)ethyl] trimethyl ammonium chloride or sulphate, [2-(acryloyloxy)ethyl] trimethyl ammonium chloride or sulphate, [3-(acrylamido) propyl] trimethyl ammonium chloride or sulphate, dimethyl diallyl ammonium chloride or sulphate, [3-(methacrylamido) propyl] trimethyl ammonium chloride or sulphate, or again at least one organofluorate or organosililate monomer, or a blend of several of these monomers,
d) possibly at least one monomer having at least two ethylenic unsaturations called in the remainder of the application a grafting monomer,

The process according to the invention is also characterised in that the said comb polymer consists:
a) of at least one anionic monomer with ethylenic unsaturation and with a monocarboxylic function chosen from among the ethylenic unsaturation monomers and with a monocarboxylic function such as acrylic or methacrylic acid, or again the diacid hemiesters such as the C₁ to C₄ monoesters of maleic or itaconic acids, or their blends, or chosen from among the monomers with ethylenic unsaturation and with a dicarboxylic function such as crotonic, isocrotonic, cinnamic, itaconic, maleic acid, or again the anhydrides of carboxylic acids, such as maleic anhydride, or chosen from among the monomers with ethylenic unsaturation and with a sulphonic function such as acrylamido-methyl-propane-sulphonic acid, sodium methallylsulphonate, vinyl sulphonic acid and styrene sulphonic acid, or again chosen from among the monomers with ethylenic unsaturation and with a phosphoric function such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function such as vinyl phosphonic acid, or their blends,
b) of a least one monomer with a non-ionic ethylenic unsaturation of formula (I):

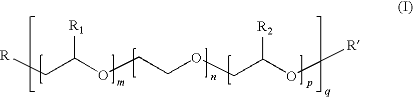

where:
   m and p represent a number of alkylene oxide units of less than or equal to 150,
   n represents a number of ethylene oxide units of less than or equal to 150,
   q represents a whole number at least equal to 1 and such that 5≦(m+n+p)q≦150, and preferentially such that 15≦(m+n+p)q≦120,
   R₁ represents hydrogen or the methyl or ethyl radical,
   R₂ represents hydrogen or the methyl or ethyl radical,
   R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends, and preferentially represents a hydrocarbonated radical having 1 to 12 carbon atoms, and very preferentially a hydrocarbonated radical having 1 to 4 carbon atoms.
or a blend of several monomers of formula (I),
c) possibly at least one monomer of the acrylamide or methacrylamide type, or their derivates such as N-[3-(dimethylamino) propyl] acrylamide or N-[3-(dimethylamino) propyl]methacrylamide, and their blends, or again of at least one non-water soluble monomer such as the alkyl acrylates or methacrylates, the unsaturated esters such as N-[2-(dimethylamino) ethyl]methacrylate, or N-[2-(dimethylamino) ethyl] acrylate, the vinylics such as vinyl acetate, vinylpyrrolidone, styrene, alphamethylstyrene and their derivates, or at least one cationic monomer or quaternary ammonium such as [2-(methacryloyloxy)ethyl] trimethyl ammonium chloride or sulphate, [2-(acryloyloxy)ethyl] trimethyl ammonium chloride or sulphate, [3-(acrylamido) propyl] trimethyl ammonium chloride or sulphate, dimethyl diallyl ammonium chloride or sulphate, [3-(methacrylamido) propyl] trimethyl ammonium chloride or sulphate, or again at least one organofluorate monomer, or indeed at least one organosililate monomer, preferentially chosen from among the molecules of formulae (IIa) or (IIb):
   with formula (IIa)

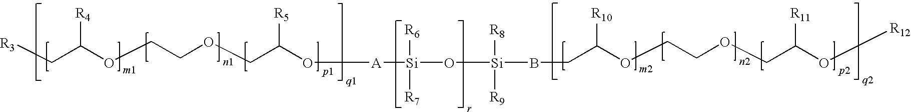

where:
   m₁, p₁, m₂ and p₂ represent a number of alkylene oxide units of less than or equal to 150,
   n₁ and n₂ represent a number of ethylene oxide units of less than or equal to 150,
   q₁ and q₂ represent a whole number at least equal to 1 and such that 0≦(m₁+n₁+p₁)q₁≦150 and 0≦(m₂+n₂+p₂)q₂≦150,
   r represents a number such that 1≦r≦200,
   R₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R₄, R₅, R₁₀ and R₁₁ represent hydrogen or the methyl or ethyl radical,
   R₆, R₇, R₈ and R₉ represent linear or branched alkyl or aryl, or alkylaryl or arylalkyl groupings, having 1 to 20 carbon atoms, or their blends,
   R₁₂ represents a hydrocarbonated radical having 1 to 40 carbon atoms,
   A and B are groupings which may be present, which then represent a hydrocarbonated radical having 1 to 4 carbon atoms,
with formula (IIb)

R-A-Si(OB)₃
where:
   R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   A is a grouping which may be present, which then represents a hydrocarbonated radical having 1 to 4 carbon atoms,
   B represents a hydrocarbonated radical having 1 to 4 carbon atoms,
or a blend of several of these monomers,
d) and possibly at least one crosslinking monomer chosen, in a non-restrictive manner, from the group constituted by ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allyl ethers obtained from polyols such as pentaerythritol, sorbitol, sucrose or others, or chosen from among the molecules of formula (III):

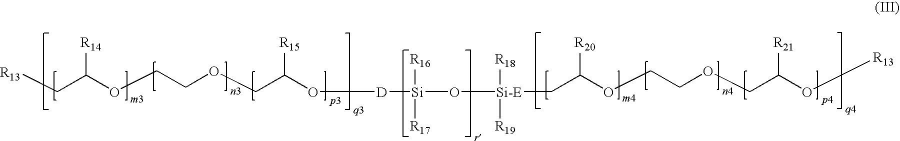

where:
   m₃, p₃, m₄ and p₄ represent a number of alkylene oxide units of less than or equal to 150,
   n₃ and n₄ represent a number of ethylene oxide units of less than or equal to 150,
   q₃ and q₄ represent a whole number at least equal to 1 and such that 0≦(m₃+n₃+p₃)q₃≦150 and 0≦(m₄+n₄+p₄)q₄≦150,
   r′ represents a number such that 1≦r′≦200,
   R₁₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R₁₄, R₁₅, R₂₀ and R₂₁, represent hydrogen or the methyl or ethyl radical,
   R₁₆, R₁₇, R₁₈ and R₁₉ represent linear or branched alkyl or aryl, or alkylaryl or arylalkyl groupings, having 1 to 20 carbon atoms, or their blends,
   D and E are groupings which may be present, which then represent a hydrocarbonated radical having 1 to 4 carbon atoms,
or a blend of several of these monomers,

The process according to the invention is also characterised in that the said comb polymer consists, expressed by weight:
a) between 2% and 95%, and more particularly between 5% and 90%, of at least one anionic monomer with ethylenic unsaturation and with a monocarboxylic function chosen from among the ethylenic unsaturation monomers and with a monocarboxylic function such as acrylic or methacrylic acid, or again the diacid hemiesters such as the C₁ to C₄ monoesters of maleic or itaconic acids, or their blends, or chosen from among the monomers with ethylenic unsaturation and with a dicarboxylic function such as crotonic, isocrotonic, cinnamic, itaconic, maleic acid, or again the anhydrides of carboxylic acids, such as maleic anhydride, or chosen from among the monomers with ethylenic unsaturation and with a sulphonic function such as acrylamido-methyl-propane-sulphonic acid, sodium methallylsulphonate, vinyl sulphonic acid and styrene sulphonic acid, or again chosen from among the monomers with ethylenic unsaturation and with a phosphoric function such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function such as vinyl phosphonic acid, or their blends, or their blends,
b) between 2 and 95%, and yet more particularly between 5% and 90%, of a least one monomer with non-ionic ethylenic unsaturation of formula (I):

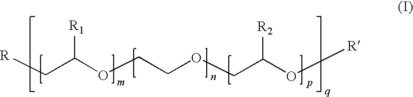

where:
   m and p represent a number of alkylene oxide units of less than or equal to 150,
   n represents a number of ethylene oxide units of less than or equal to 150,
   q represents a whole number at least equal to 1 and such that 5≦(m+n+p)q≦150, and preferentially such that 15≦(m+n+p)q≦120,
   R₁ represents hydrogen or the methyl or ethyl radical,
   R₂ represents hydrogen or the methyl or ethyl radical,
   R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends, and preferentially represents a hydrocarbonated radical having 1 to 12 carbon atoms, and very preferentially a hydrocarbonated radical having 1 to 4 carbon atoms.
or a blend of several monomers of formula (I),
c) between 0% and 50% of at least one monomer of the acrylamide or methacrylamide type, or their derivates such as N-[3-(dimethylamino) propyl] acrylamide or N-[3-(dimethylamino) propyl]methacrylamide, and their blends, or again of at least one non-water soluble monomer such as the alkyl acrylates or methacrylates, the unsaturated esters such as N-[2-(dimethylamino) ethyl]methacrylate, or N-[2-(dimethylamino) ethyl] acrylate, the vinylics such as vinyl acetate, vinylpyrrolidone, styrene, alphamethylstyrene and their derivates, or at least one cationic monomer or quaternary ammonium such as [2-(methacryloyloxy)ethyl] trimethyl ammonium chloride or sulphate, [2-(acryloyloxy)ethyl] trimethyl ammonium chloride or sulphate, [3-(acrylamido) propyl] trimethyl ammonium chloride, dimethyl diallyl ammonium chloride or sulphate, [3-(methacrylamido) propyl] trimethyl ammonium chloride or sulphate, or again one organofluorate monomer, or indeed one organosililate monomer, preferentially chosen from among the molecules of formulae (IIa) or (IIb):
   with formula (IIa)

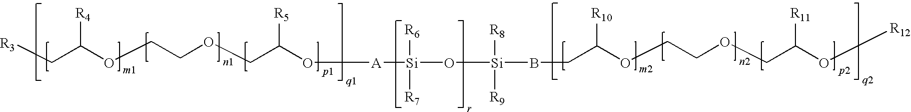

where:
   m₁, p₁, m₂ and p₂ represent a number of alkylene oxide units of less than or equal to 150,
   n₁ and n₂ represent a number of ethylene oxide units of less than or equal to 150,
   q₁ and q₂ represent a whole number at least equal to 1 and such that 0≦(m₁+n₁+p₁)q₁≦150 and 0≦(m₂+n₂+p₂)q₂≦150,
   r represents a number such that 1≦r≦200,
   R₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R₄, R₅, R₁₀ and R₁₁ represent hydrogen or the methyl or ethyl radical,
   R₆, R₇, R₈ and R₉ represent linear or branched alkyl or aryl, or alkylaryl or arylalkyl groupings, having 1 to 20 carbon atoms, or their blends,
   R₁₂ represents a hydrocarbonated radical having 1 to 40 carbon atoms,
   A and B are groupings which may be present, which then represent a hydrocarbonated radical having 1 to 4 carbon atoms,
with formula (IIb)

R-A-Si(OB)₃
where:
   R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   A is a grouping which may be present, which then represents a hydrocarbonated radical having 1 to 4 carbon atoms,
   B represents a hydrocarbonated radical having 1 to 4 carbon atoms,
or a blend of several of these monomers,
d) between 0% and 3% of at least one crosslinking monomer chosen, in a non-restrictive manner, from the group constituted by ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allyl ethers obtained from polyols such as pentaerythritol, sorbitol, sucrose or others, or chosen from among the molecules of formula (III):

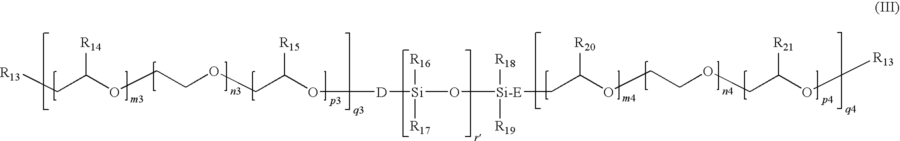

where:
   m₃, p₃, m₄ and p₄ represent a number of alkylene oxide units of less than or equal to 150,
   n₃ and n₄ represent a number of ethylene oxide units of less than or equal to 150,
   q₃ and q₄ represent a whole number at least equal to 1 and such that 0≦(m₃+n₃+p₃)q₃≦150 and 0≦(m₄+n₄+p₄)q₄≦150,
   r′ represents a number such that 1≦r′≦200,
   R₁₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as, for example, acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R₁₄, R₁₅, R₂₀ and R₂₁, represent hydrogen or the methyl or ethyl radical,
   R₁₆, R₁₇, R₁₈ and R₁₉ represent linear or branched alkyl or aryl, or alkylaryl or arylalkyl groupings, having 1 to 20 carbon atoms, or their blends,
   D and E are groupings which may be present, which then represent a hydrocarbonated radical having 1 to 4 carbon atoms,
or a blend of several of these monomers,
   where the total proportions of the constituents a), b), c) and d) is equal to 100%.

The polymer used according to the invention is obtained by known processes of radical copolymerisation in solution, in a direct or reverse emulsion, in suspension or in precipitation in appropriate solvents, in the presence of catalytic systems and known transfer agents, or again by controlled radical polymerisation processes such as the method known as Reversible Addition Fragmentation Transfer (RAFT), the method known as Atom Transfer Radical Polymerization (ATRP), the method known as Nitroxide Mediated Polymerization (NMP) or again the method known as Cobaloxime Mediated Free Radical Polymerization.

This polymer obtained in the acid form, and possibly distilled, may also be partially or totally neutralised by one or more neutralisation agents having a monovalent neutralising function or a polyvalent neutralising function such as, for example, for the monovalent function of those chosen from the group constituted by the alkaline cations, in particular sodium, potassium, lithium, ammonium or the primary, secondary or tertiary aliphatic and/or cyclic amines, such as, for example, stearylamine, the ethanolamines (mono-, di-, triethanolamine), mono- and diethylamine, cyclohexylamine, methylcyclohexylamine, amino methyl propanol, morpholine, or again, for the polyvalent function, those chosen from the group constituted by the alkaline earth divalent cations, in particular magnesium and calcium, or again zinc, and also by the trivalent cations, in particular aluminium, or again by certain cations of higher valency.

Each neutralisation agent then acts with neutralisation rates inherent to each valency function.

According to another variant, the polymer derived from the polymerisation reaction may also be, before or after the total or partial neutralisation reaction, treated and separated into several phases, according to static or dynamic processes known to the skilled man in the art, by one or more polar solvents belonging notably to the group constituted by water, methanol, ethanol, propanol, isopropanol, the butanols, acetone, tetrahydrofuran or their blends.

One of the phases then corresponds to the polymer used according to the invention. According to another variant, the said polymer may be dried.

Another object of the invention lies in the paper coatings obtained by the process according to the invention.

The final object of the invention is the use of paper coatings according to the invention for coating of paper and card.

The scope and interest of the invention will be better appreciated through the following examples, which are by no means limitative.

### EXAMPLES

### Example 1

This example illustrates the process of manufacture of paper coatings according to the invention, a coating in which a comb polymer, obtained by grafting of at least one polyalkylene oxide function on to the polymer chain, where the said chain results from the polymerisation of at least one ethylenic unsaturated monomer, is introduced directly, in the form of an aqueous solution.

### Manufacture of the Paper Coatings

For each of the tests n^{o} 1 to 7, a paper coating is produced by blending of:
100 parts by dry weight of an aqueous suspension of calcium carbonate which is Norwegian marble, and which is sold by the company OMYA™ under the name Hydrocarb™ 90, of which the content by dry weight of calcium carbonate is equal to 78% of the total weight of the suspension;
10 parts by dry weight of styrene-butadiene latex sold by the company DOW™ CHEMICALS under the name DL 966, for 100 parts by dry weight of calcium carbonate;
a certain quantity of the polymer for testing (according to the invention or according to the prior art), where this quantity is expressed as parts by dry weight of polymer, for 100 parts by dry weight of calcium carbonate.

A paper coating is obtained by this means, the content by dry weight of which is determined at 69% of the total weight of the said coating.

### Measurement of the Brookfield™ Viscosity

For each of the coatings thus formulated, the Brookfield™ viscosity is firstly measured, at 25° C. and at 100 RPM, noted μ₁₀₀ according to the method well known to the skilled man in the art.

### Measurement of Water Retention

For each coating a water retention value is then determined, according to the following method.

The water retention is determined using a device of the AAGWR type sold by the company GRADEK™.

This device consists of a measuring chamber, in which a test paper called a “Test Blotter Paper” is placed, covered by a perforated plastic sheet called a “Test Filter PCTE”, the paper and the sheet being sold by the company GRADEK™.

10 ml of the paper coating for testing is then introduced into the chamber.

The AAGWR device enables a certain pressure to be exerted on the paper coating, leading all or part of the water and of the water-soluble substances contained in the coating to traverse the perforated plastic sheet and migrate into the test paper.

Specifically, a pressure of 0.5 bar is applied for 90 seconds.

The difference between the weight of the test paper before the experiment P₀, and after the experiment P₁, gives the weight of water and of water-soluble substances contained in the paper coating having migrated into the test paper during the experiment.

Specifically, a value for the increase of water retention, noted R_{%}, is determined, equal to: (P₁−P₀)/P₀*100.

Specifically, a value for the increase of water retention is determined, equal to: (P₁−P₀)/P₀.

This value is determined when no polymer is used in the paper coating:

R₀=[(P₁−P₀)/P₀]_{quantity of polymer=0}

For each of the polymers used, the relative water retention increase value is determined as a function of the quantity of polymer x used:

Rₓ=[(P₁−P₀)/P₀]_{quantity of polymer=x}

For a quantity x of polymer used, the following is then represented:

R_{%}=(Rₓ−R₀)/R₀*100 as a function of the Brookfield viscosity μ₁₀₀.

### Test N^{o} 1

This test illustrates the prior art and uses a cellulose carboxymethyl sold by the company HUBER™ under the name Finnfix™ 10, in a proportion equal, expressed in parts of dry CMC for 100 parts by dry weight of calcium carbonate, to:
0.2 for test 1-a
0.45 for test 1-b
0.7 for test 1-c

### Test N^{o} 2

This test illustrates the prior art and uses a copolymer of methacrylic acid and of ethyl acrylate, in a proportion equal, expressed in parts by dry weight of copolymer for 100 parts by dry weight of calcium carbonate, to:
0.2 for test 2-a
0.3 for test 2-b
0.55 for test 2-c

### Test N^{o} 3

This test illustrates the invention and uses a polymer consisting, expressed as a percentage by weight of monomers, of:
5.9% acrylic acid
1.6% methacrylic acid
92.5% methoxy polyethylene glycol methacrylate of molecular weight equal to 5,000 g/mole
   where the said polymer has a molecular weight equal to 2,560,000 g/mole.

This polymer is used in a proportion equal, expressed in parts by dry weight of polymer for 100 parts by dry weight of calcium carbonate, to:
0.3 for test 3-a
0.8 for test 3-b
1.2 for test 3-c
3.0 for test 3-d

### Test N^{o} 4

This test illustrates the invention and uses a polymer consisting, expressed as a percentage by weight of monomers, of:
5.9% acrylic acid
1.6% methacrylic acid
92.5% methoxy polyethylene glycol methacrylate of molecular weight equal to 5,000 g/mole
   where the said polymer has a molecular weight as determined by GPC equal to 950,000 g/mole.

This polymer is used in a proportion equal, expressed in parts by dry weight of polymer for 100 parts by dry weight of calcium carbonate, to:
0.3 for test 4-a
0.8 for test 4-b
1.2 for test 4-c

### Test N^{o} 5

This test illustrates the invention and uses a polymer consisting, expressed as a percentage by weight of monomers, of:
5.9% acrylic acid
1.6% methacrylic acid
92.5% methoxy polyethylene glycol methacrylate of molecular weight equal to 5,000 g/mole
   where the said polymer has a molecular weight equal to 4,350,000 g/mole.

This polymer is used in a proportion equal, expressed in parts by dry weight of polymer for 100 parts by dry weight of calcium carbonate, to:
0.3 for test 5-a
0.8 for test 5-b
1.2 for test 5-c

For each of the tests n^{o} 1 to 5, the values of the Brookfield™ viscosity measured at 25° C. and at 100 RPM (μ₁₀₀), together with the relative increase of the water retention (R_{%}), are given in table 1.

Furthermore, it is indicated that the value of μ₁₀₀ is equal to 112 mPa·s for the coating not containing any additive, and that the value of water retention P₁−P₀ is equal to 239 grams for this same coating not containing any additive.

TABLE 1
Brookfield ™ viscosity measured at 25° C. and at 100
RPM (μ₁₀₀) and relative increase of the water retention (R_{%})

| | Prior Art/ | μ₁₀₀ | |
|---|---|---|---|
| Test n° | Invention | (mPa · s) | R_{%} (%) |
| 1-a | Prior Art | 800 | 33 |
| 1-b | Prior Art | 1800 | 46 |
| 1-c | Prior Art | 2800 | 49 |
| 2-a | Prior Art | 1100 | 58 |
| 2-b | Prior Art | 1450 | 69 |
| 2-c | Prior Art | 2600 | 74 |
| 3-a | Invention | 216 | 35 |
| 3-b | Invention | 570 | 57 |
| 3-c | Invention | 917 | 65 |
| 3-d | Invention | 1600 | 83 |
| 4-a | Invention | 198 | 32 |
| 4-b | Invention | 575 | 49 |
| 4-c | Invention | 940 | 61 |
| 5-a | Invention | 436 | 37 |
| 5-b | Invention | 704 | 63 |
| 5-c | Invention | 1106 | 72 |

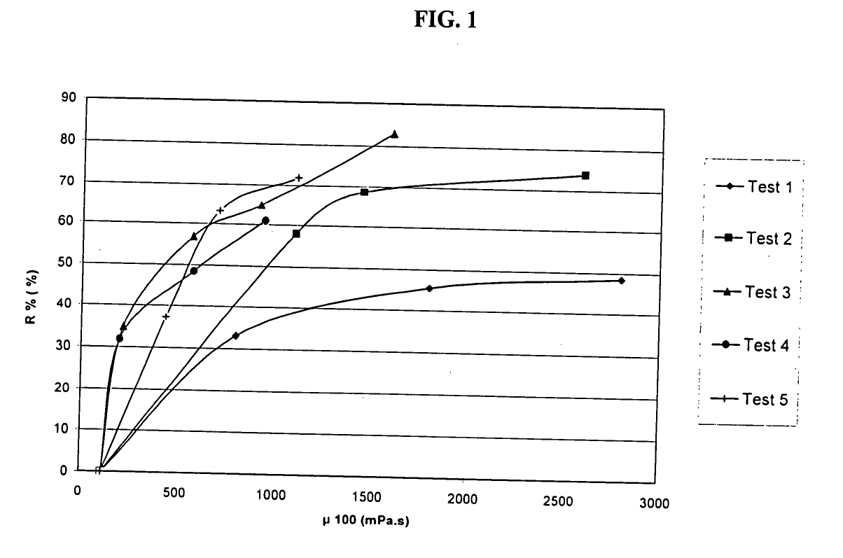

These results have been represented in FIG. 1.

An examination of this figure clearly shows that the use of comb polymers according to the invention enables the water retention/Brookfield™ viscosity pair to be improved, i.e. that the following is obtained:
for a given Brookfield™ viscosity, a better (higher) water retention than with the use of a water-retaining thickening agent of the prior art in the paper coating,
or for a given water retention, a better (lower) Brookfield™ viscosity than with the use of a water-retaining thickening agent of the prior art in the paper coating.

### Example 2

This example illustrates the process of manufacture of paper coatings according to the invention, a coating in which a comb polymer, obtained by grafting of at least one polyalkylene oxide function on to the polymer chain, where the said chain results from the polymerisation of at least one ethylenic unsaturated monomer, is introduced directly, in the form of an aqueous solution.

### Manufacture of the Paper Coatings

For each of the tests n^{o} 6 to 14, a paper coating is produced by blending of:
100 parts by dry weight of an aqueous suspension of calcium carbonate which is Norwegian marble, and which is sold by the company OMYA™ under the name Hydrocarb™ 90, the content of which by dry weight of calcium carbonate is equal to 78% of the total weight of the suspension;
11 parts by dry weight of styrene-butadiene latex sold by the company DOW™ CHEMICALS under the name DL 966, for 100 parts by dry weight of calcium carbonate;
0.4 parts by dry weight of polyvinylic alcohol for 100 parts by dry weight of calcium carbonate;
1 part by dry weight of optical brightener sold by the company BAYER™ under the name Blancophor™ P, for 100 parts by dry weight of calcium carbonate;
the polymer for testing (according to the invention or according to the prior art), in 2 quantities equal to 0.4 and 0.6 parts by dry weight of the said polymer, for 100 parts by dry weight of calcium carbonate.

A paper coating is obtained by this means, the content by dry weight of which is determined at 68% of the total weight of the said coating.

### Measurement of the Brookfield™ Viscosity

For each of the coatings thus formulated, the Brookfield™ viscosity is firstly measured, at 25° C. and at 100 RPM, noted μ₁₀₀ according to the method well known to the skilled man in the art.

### Measurement of Water Retention

For each coating a water retention value is then determined, according to the method as described in example 1.

### Test N^{o} 6

This test illustrates the prior art and uses a carboxymethyl cellulose sold by the company METSA SERLA™ under the name Finnfix™ 10.

### Test N^{o} 7

This test illustrates the invention and uses a polymer consisting, expressed as a percentage by weight of monomers, of:
5.9% acrylic acid
1.6% methacrylic acid
92.5% of methoxy polyethylene glycol methacrylate of molecular weight equal to 5,000 g/mole
   where the said polymer has a molecular weight equal to 2,560,000 g/mole.

### Test N^{o} 8

This test illustrates the invention and uses a polymer consisting, expressed as a percentage by weight of monomers, of:
6.0% acrylic acid
94% of methoxy polyethylene glycol methacrylate of molecular weight equal to 750 g/mole
   where the said polymer has a molecular weight equal to 1,574,000 g/mole.

### Test N^{o} 9

This test illustrates the invention and uses a polymer consisting, expressed as a percentage by weight of monomers, of:
6% acrylic acid
94% of methoxy polyethylene glycol methacrylate of molecular weight equal to 2,000 g/mole
   where the said polymer has a molecular weight equal to 2,085,000 g/mole.

### Test N^{o} 10

This test illustrates the invention and uses a polymer consisting, expressed as a percentage by weight of monomers, of:
30% acrylic acid
70% methoxy polyethylene glycol methacrylate of molecular weight equal to 5,000 g/mole
   where the said polymer has a molecular weight equal to 60,000 g/mole.

### Test N^{o} 11

This test illustrates the invention and uses a polymer consisting, expressed as a percentage by weight of monomers, of:
40% acrylic acid
60% methoxy polyethylene glycol methacrylate of molecular weight equal to 5,000 g/mole
   where the said polymer has a molecular weight equal to 67,000 g/mole.

### Test N^{o} 12

This test illustrates the invention and uses a polymer consisting, expressed as a percentage by weight of monomers, of:
5.0% acrylic acid
2.6% of acrylamidomethylpropanesulfonic acid
92.4% methoxy polyethylene glycol methacrylate of molecular weight equal to 5,000 g/mole
   where the said polymer has a molecular weight equal to 460,000 g/mole.

### Test N^{o} 13

This test illustrates the invention and uses a polymer consisting, expressed as a percentage by weight of monomers, of:
15.6% ethylene glycol methacrylate phosphate
84.4% methoxy polyethylene glycol methacrylate of molecular weight equal to 5,000 g/mole
   where the said polymer has a molecular weight equal to 2,560,000 g/mole.

### Test N^{o} 14

This test illustrates the invention and uses a polymer consisting, expressed as a percentage by weight of monomers, of:
6.0% acrylic acid
94.0% methoxy polyethylene glycol methacrylate of molecular weight equal to 3,000 g/mole
   where the said polymer has a molecular weight equal to 2,560,000 g/mole.

As in example 1, for a quantity x (here equal to 0, 0.4 and 0.6 parts by dry weight of the said polymer for 100 parts of calcium carbonate) of polymer used, the following is represented:

R_{%}=(Rₓ−R₀)/R₀*100 as a function of the Brookfield viscosity μ₁₀₀.

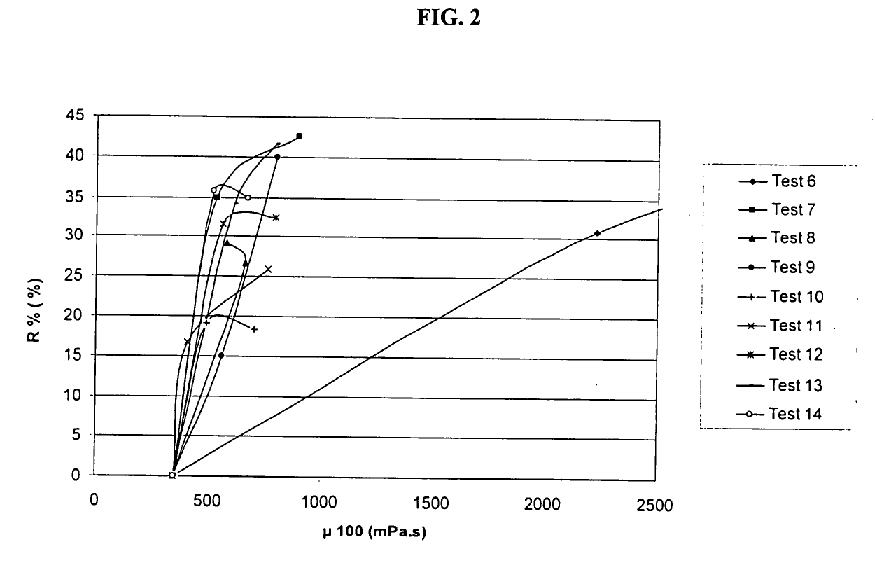

This representation is in FIG. 2.

An examination of this figure clearly shows that the use of comb polymers according to the invention enables the water retention/Brookfield™ viscosity pair to be improved, i.e. that the following is obtained:
for a given Brookfield™ viscosity, a better (higher) water retention than with the use of a water-retaining thickening agent of the prior art in the paper coating,
or for a given water retention, a better (lower) Brookfield™ viscosity than with the use of a water-retaining thickening agent of the prior art in the paper coating.

### Example 3

This example illustrates the process of manufacture of paper coatings according to the invention, a coating in which a comb polymer, obtained by grafting of at least one polyalkylene oxide function on to the polymer chain, where the said chain results from the polymerisation of at least one ethylenic unsaturated monomer, is introduced. This polymer is introduced in the form of an aqueous dispersion of calcium carbonate, the said polymer having been used to disperse the said calcium carbonate in water.

### Manufacture of the Paper Coatings

For each of the tests n^{o} 15 to 17, a paper coating is produced by blending of:
100 parts by dry weight of an aqueous suspension of calcium carbonate which is a marble from Norway, the content of which by dry weight of calcium carbonate is equal to 78% of the total weight of the dispersion, and containing a polymer having been used for grinding or for dispersing the said calcium carbonate, where the said polymer is a polymer of the prior art or the polymer according to the invention;
11 parts by dry weight of styrene-butadiene latex sold by the company DOW™ CHEMICALS under the name DL 966, for 100 parts by dry weight of calcium carbonate;
0.6 parts by dry weight of a carboxymethyl cellulose sold by the company METSA SERLA™ under the name Finnfix™ 10;
0.3 parts by dry weight of polyvinylic alcohol for 100 parts by dry weight of calcium carbonate;
0.5 part by dry weight of optical brightener sold by the company BAYER™ under the name Blancophor™ P, for 100 parts by dry weight of calcium carbonate;

A paper coating is obtained by this means, the content by dry weight of which is determined at 67% of the total weight of the said coating.

### Measurement of the Brookfield™ Viscosity

For each of the coatings thus formulated, the Brookfield™ viscosity is firstly measured, at 25° C. and at 100 RPM, noted μ₁₀₀ according to the method well known to the skilled man in the art.

### Measurement of Water Retention

For each coating a water retention value is then determined, according to the method as described in example 1.

### Test N^{o} 15

This test illustrates the prior art and uses 2% by dry weight of a homopolymer of acrylic acid relative to the dry weight of calcium carbonate, to disperse the said calcium carbonate in water.

### Test N^{o} 16

This test illustrates the invention and uses 2% by dry weight of a polymer (relative to the dry weight of calcium carbonate) consisting of, expressed as a percentage by weight of the monomers:
5.9% acrylic acid
1.6% methacrylic acid
92.5% of methoxy polyethylene glycol methacrylate of molecular weight equal to 5,000 g/mole
   where the said polymer has a molecular weight equal to 2,560,000 g/mole.

This polymer was used to disperse the calcium carbonate in water.

### Test N^{o} 17

This test illustrates the invention and uses 2% by dry weight of a polymer (relative to the dry weight of calcium carbonate) consisting of, expressed as a percentage by weight of the monomers:
5.9% acrylic acid
1.6% methacrylic acid
92.5% of methoxy polyethylene glycol methacrylate of molecular weight equal to 5,000 g/mole
   where the said polymer has a molecular weight equal to 2,560,000 g/mole.

This polymer was used to grind the calcium carbonate in water.

The values of the Brookfield viscosity measured at 100 revolutions/minute and of the water retention, as indicated above, have been indicated in table 2, in respect of the paper coatings corresponding to tests n^{o} 15 to 17.

TABLE 3

| | | Brookfield | |
|---|---|---|---|
| | Prior Art/ | viscosity | Water retention |
| Test n° | Invention | 100 rpm (mPa · s) | (g/m2) |
| 15 | Prior Art | 2800 | 138 |
| 16 | Invention | 1400 | 113 |
| 17 | Invention | 1150 | 105 |

A reading of table 3 demonstrates that the polymers used according to the invention enable the Brookfield viscosity of the paper coatings to be reduced, whilst improving their water retention.

1. A process to manufacture paper coatings, where the said coatings contain:
(a) at least one mineral matter,
(b) at least one binder,
(c) water,
characterised in that is introduced into the above-mentioned composition, an agent enabling the water retention to be increased and the Brookfield™ viscosity of the composition to be reduced, this agent comprising at least one comb polymer, obtained by grafting at least one polyalkylene oxide function on to the polymer chain, where the said chain results from polymerisation of at least one ethylenic unsaturated monomer.

2. A process according to claim 1, characterised in that the said polymer is introduced:
1. with the mineral matter, in the form of dry powder, and/or of aqueous dispersion and/or of aqueous suspension, resulting from the stages of:
grinding and/or dispersion in a wet medium and preferentially aqueous medium of the mineral matter in the presence of the said polymer, and possibly in the presence of at least one grinding agent by a wet method and/or of at least one dispersing agent, leading to an aqueous dispersion and/or suspension of the mineral matter being obtained;
and in the case of the dry powder only, of drying of the aqueous dispersion and/or suspension of the mineral matter, possibly followed by processing and classification of the powder obtained;
2. and/or with the mineral matter, in the form of an aqueous dispersion and/or an aqueous suspension, resulting from the stages of:
dry grinding of the mineral filler, possibly in the presence of at least one dry grinding agent, possibly followed by processing and classification of the powder obtained;
aqueous dispersion and/or suspension of the powder obtained, with introduction of the said polymer and possibly in the presence of a dispersing agent;
3. and/or with the mineral matter, in the form of dry powder, and/or aqueous dispersion and/or aqueous suspension, resulting from the stages of:
introduction of the said polymer into a dispersion and/or into an aqueous suspension containing the mineral matter;
and in the case of the dry powder only, of drying of the aqueous dispersion and/or suspension of the mineral matter, possibly followed by processing and classification of the powder obtained;
4. and/or in the form of dry powder mixed with the other constituents a), b) and c);
5. and/or in the form of an aqueous solution mixed with the other constituents a), b) and c);

3. A process according to claim 1, characterised in that the paper coating contains, as a percentage by weight of each constituent relative to the total weight of the paper coating:
(a) 3 to 20 parts, and preferentially 5 to 15 parts, by dry weight of binder, for 100 parts by dry weight of mineral matter,
(b) 0.1 to 2 parts, and preferentially 0.1 to 1.5 parts, by dry weight of comb polymer, for 100 parts by dry weight of mineral matter,
(c) water in a quantity by weight of between 20% and 80%, relative to the total weight of the paper coating.

4. A process according to claim 1, characterised in that at least one water-retaining agent and/or thickening agent other than the comb polymer used is also used.

5. A process according to claim 1, characterised in that the mineral matter is chosen from among natural or synthetic calcium carbonate, the dolomites, kaolin, talc, gypsum, titanium dioxide, satin white or again aluminium trihydroxide, mica, carbon black and a blend of more than one of these fillers together, such as talc-calcium carbonate, calcium carbonate-kaolin blends, or again blends of calcium carbonate with aluminium trihydroxide, or again blends with synthetic or natural fibres, or again mineral co-structures such as talc-calcium carbonate or talc-titanium dioxide co-structures, preferentially chosen from among natural or synthetic calcium carbonate, kaolin, talc and blends of these fillers, and very preferentially chosen from among natural or synthetic calcium carbonate or their blends, and even more preferentially chosen from among marble, calcite, chalk or their blends.

6. A process according to claim 1, characterised in that the binder is chosen from among the water-soluble binders and notably starch, or from among the synthetic latex polymer binders, such as styrene-acrylic and the styrene-butadienes or their blends, or the blends of these binders.

7. A process according to claim 1, characterised in that the comb polymers have a molecular weight noted M_{w} of between 100,000 g/mole and 10,000,000 g/mole, and preferentially between 1,000,000 g/mole and 7,000,000 g/mole.

8. A process according to claim 1, characterised in that the comb polymers contain at least one monomer of formula (I): 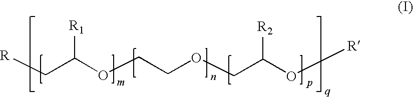
where:
m and p represent a number of alkylene oxide units of less than or equal to 150,
n represents a number of ethylene oxide units of less than or equal to 150,
q represents an integer at least equal to 1 and such that 5≦(m+n+p)q≦150,
R₁ represents hydrogen or the methyl or ethyl radical,
R₂ represents hydrogen or the methyl or ethyl radical,
R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends.

9. A process according to claim 1, characterised in that the comb polymers is comprised:
(a) of at least one anionic monomer with a carboxylic or dicarboxylic or phosphoric or phosphonic or sulphonic function, or their blends,
(b) of at least one non-ionic monomer, where the non-ionic monomer consists of at least one monomer of formula (I): 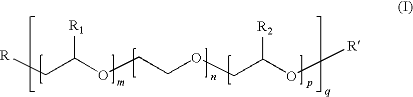
where:
m and p represent a number of alkylene oxide units of less than or equal to 150,
n represents a number of ethylene oxide units of less than or equal to 150,
q represents an integer at least equal to 1 and such that 5≦(m+n+p)q≦150, and preferentially such that 15≦(m+n+p)q≦120-R₁ represents hydrogen or the methyl or ethyl radical,
R₂ represents hydrogen or the methyl or ethyl radical,
R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends, and preferentially represents a hydrocarbonated radical having 1 to 12 carbon atoms, and very preferentially a hydrocarbonated radical having 1 to 4 carbon atoms.
or a blend of several monomers of formula (I),
(c) possibly at least one monomer of the acrylamide or methacrylamide type, or their derivates such as N-[3-(dimethylamino) propyl] acrylamide or N-[3-(dimethylamino) propyl]methacrylamide, and their blends, or again of at least one non-water soluble monomer such as the alkyl acrylates or methacrylates, the unsaturated esters such as N-[2-(dimethylamino) ethyl]methacrylate, or N-[2-(dimethylamino) ethyl] acrylate, the vinylics such as vinyl acetate, vinylpyrrolidone, styrene, alphamethylstyrene and their derivates, or at least one cationic monomer or quaternary ammonium such as [2-(methacryloyloxy)ethyl] trimethyl ammonium chloride or sulphate, [2-(acryloyloxy)ethyl] trimethyl ammonium chloride or sulphate, [3-(acrylamido) propyl] trimethyl ammonium chloride or sulphate, dimethyl diallyl ammonium chloride or sulphate, [3-(methacrylamido) propyl] trimethyl ammonium chloride or sulphate, or again at least one organofluorate or organosililate monomer, or a blend of several of these monomers,
(d) possibly at least one monomer having at least two ethylenic unsaturations.

10. A process according to claim 1, characterised in that the comb polymer is comprised:
(a) of at least one anionic monomer with ethylenic unsaturation and with a monocarboxylic function chosen from among the ethylenic unsaturation monomers and with a monocarboxylic function such as acrylic or methacrylic acid, or again the diacid hemiesters such as the C₁ to C₄ monoesters of maleic or itaconic acids, or their blends, or chosen from among the monomers with ethylenic unsaturation and with a dicarboxylic function such as crotonic, isocrotonic, cinnamic, itaconic, maleic acid, or again the anhydrides of carboxylic acids, such as maleic anhydride, or chosen from among the monomers with ethylenic unsaturation and with a sulphonic function such as acrylamido-methyl-propane-sulphonic acid, sodium methallylsulphonate, vinyl sulphonic acid and styrene sulphonic acid, or again chosen from among the monomers with ethylenic unsaturation and with a phosphoric function such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function such as vinyl phosphonic acid, or their blends,
(b) of a least one monomer with a non-ionic ethylenic unsaturation of formula (I): 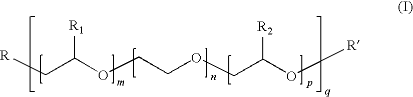
where:
m and p represent a number of alkylene oxide units of less than or equal to 150,
n represents a number of ethylene oxide units of less than or equal to 150,
q represents a whole number at least equal to 1 and such that 5≦(m+n+p)q≦150, and preferentially such that 15≦(m+n+p)q≦120,
R₁ represents hydrogen or the methyl or ethyl radical,
R₂ represents hydrogen or the methyl or ethyl radical,
R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends, and preferentially represents a hydrocarbonated radical having 1 to 12 carbon atoms, and very preferentially a hydrocarbonated radical having 1 to 4 carbon atoms.
or a blend of several monomers of formula (I),
(c) possibly at least one monomer of the acrylamide or methacrylamide type, or their derivates such as N-[3-(dimethylamino) propyl] acrylamide or N-[3-(dimethylamino) propyl]methacrylamide, and their blends, or again of at least one non-water soluble monomer such as the alkyl acrylates or methacrylates, the unsaturated esters such as N-[2-(dimethylamino) ethyl]methacrylate, or N-[2-(dimethylamino) ethyl] acrylate, the vinylics such as vinyl acetate, vinylpyrrolidone, styrene, alphamethylstyrene and their derivates, or at least one cationic monomer or quaternary ammonium such as [2-(methacryloyloxy)ethyl] trimethyl ammonium chloride or sulphate, [2-(acryloyloxy)ethyl] trimethyl ammonium chloride or sulphate, [3-(acrylamido) propyl] trimethyl ammonium chloride or sulphate, dimethyl diallyl ammonium chloride or sulphate, [3-(methacrylamido) propyl] trimethyl ammonium chloride or sulphate, or again at least one organofluorate monomer, or indeed at least one organosililate monomer, preferentially chosen from among the molecules of formulae (IIa) or (IIb):
with formula (IIa) 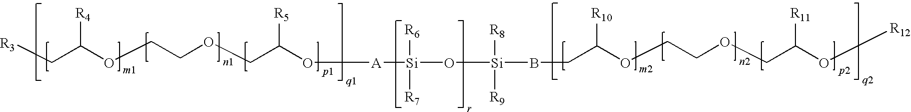
where:
m₁, p₁, m₂ and p₂ represent a number of alkylene oxide units of less than or equal to 150,
n₁ and n₂ represent a number of ethylene oxide units of less than or equal to 150,
q₁ and q₂ represent a whole number at least equal to 1 and such that 0≦(m₁+n₁+p₁)q₁≦150 and 0≦(m₂+n₂+p₂)q₂≦150,
r represents a number such that 1≦r≦200,
R₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R₄, R₅, R₁₀ and R₁₁, represent hydrogen or the methyl or ethyl radical,
R₆, R₇, R₈ and R₉ represent linear or branched alkyl or aryl, or alkylaryl or arylalkyl groupings, having 1 to 20 carbon atoms, or their blends,
R₁₂ represents a hydrocarbonated radical having 1 to 40 carbon atoms,
A and B are groupings which may be present, which then represent a hydrocarbonated radical having 1 to 4 carbon atoms,
with formula (IIb)
R-A-Si(OB)₃
where:
R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
A is a grouping which may be present, which then represents a hydrocarbonated radical having 1 to 4 carbon atoms,
B represents a hydrocarbonated radical having 1 to 4 carbon atoms,
or a blend of several of these monomers,
(d) and possibly at least one crosslinking monomer chosen from the group constituted by ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allyl ethers obtained from polyols such as pentaerythritol, sorbitol, sucrose or others, or chosen from among the molecules of formula (III): 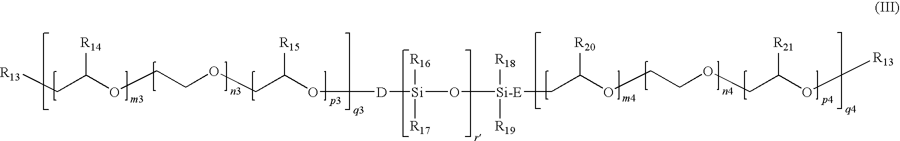
where:
m₃, p₃, m₄ and p₄ represent a number of alkylene oxide units of less than or equal to 150,
n₃ and n₄ represent a number of ethylene oxide units of less than or equal to 150,
q₃ and q₄ represent a whole number at least equal to 1 and such that 0≦(m₃+n₃+p₃)q₃≦150 and 0≦(m₄+n₄+p₄)q₄≦150,
r′ represents a number such that 1≦r′≦200,
R₁₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉ represent linear or branched alkyl or aryl, or alkylaryl or arylalkyl groupings, having 1 to 20 carbon atoms, or their blends,
D and E are groupings which may be present, which then represent a hydrocarbonated radical having 1 to 4 carbon atoms,
or a blend of several of these monomers,

11. A process according to claim 1, characterised in that the said comb polymer is comprised, expressed by weight, of:
(a) between 2% and 95%, and more particularly between 5% and 90%, of at least one anionic monomer with ethylenic unsaturation and with a monocarboxylic function chosen from among the ethylenic unsaturation monomers and with a monocarboxylic function such as acrylic or methacrylic acid, or again the diacid hemiesters such as the C₁ to C₄ monoesters of maleic or itaconic acids, or their blends, or chosen from among the monomers with ethylenic unsaturation and with a dicarboxylic function such as crotonic, isocrotonic, cinnamic, itaconic, maleic acid, or again the anhydrides of carboxylic acids, such as maleic anhydride, or chosen from among the monomers with ethylenic unsaturation and with a sulphonic function such as acrylamido-methyl-propane-sulphonic acid, sodium methallylsulphonate, vinyl sulphonic acid and styrene sulphonic acid, or again chosen from among the monomers with ethylenic unsaturation and with a phosphoric function such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function such as vinyl phosphonic acid, or their blends, or their blends,
(b) between 2 and 95%, and yet more particularly between 5% and 90%, of a least one monomer with non-ionic ethylenic unsaturation of formula (I): 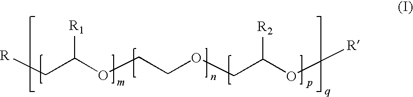
where:
m and p represent a number of alkylene oxide units of less than or equal to 150,
n represents a number of ethylene oxide units of less than or equal to 150,
q represents a whole number at least equal to 1 and such that 5≦(m+n+p)q≦150, and preferentially such that 15≦(m+n+p)q≦120,
R₁ represents hydrogen or the methyl or ethyl radical,
R₂ represents hydrogen or the methyl or ethyl radical,
R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R′ represents hydrogen or a hydrocarbonated radical having 1 to 40 carbon atoms, or an ionic or ionisable grouping such as a phosphate, a phosphonate, a sulphate, a sulphonate, a carboxylic, or indeed a primary, secondary or tertiary amine, or a quaternary ammonium, or indeed their blends, and preferentially represents a hydrocarbonated radical having 1 to 12 carbon atoms, and very preferentially a hydrocarbonated radical having 1 to 4 carbon atoms.
or a blend of several monomers of formula (I),
(c) between 0% and 50% of at least one monomer of the acrylamide or methacrylamide type, or their derivates such as N-[3-(dimethylamino) propyl] acrylamide or N-[3-(dimethylamino) propyl]methacrylamide, and their blends, or again of at least one non-water soluble monomer such as the alkyl acrylates or methacrylates, the unsaturated esters such as N-[2-(dimethylamino) ethyl]methacrylate, or N-[2-(dimethylamino) ethyl] acrylate, the vinylics such as vinyl acetate, vinylpyrrolidone, styrene, alphamethylstyrene and their derivates, or at least one cationic monomer or quaternary ammonium such as [2-(methacryloyloxy)ethyl] trimethyl ammonium chloride or sulphate, [2-(acryloyloxy)ethyl] trimethyl ammonium chloride or sulphate, [3-(acrylamido) propyl] trimethyl ammonium chloride, dimethyl diallyl ammonium chloride or sulphate, [3-(methacrylamido) propyl] trimethyl ammonium chloride or sulphate, or again one organofluorate monomer, or indeed one organosililate monomer, preferentially chosen from among the molecules of formulae (IIa) or (IIb):
with formula (IIa) 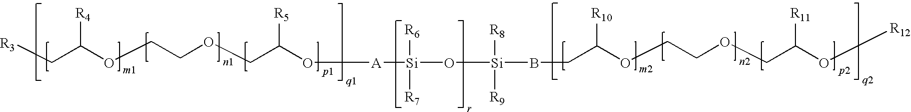
where:
m₁, p₁, m₂ and p₂ represent a number of alkylene oxide units of less than or equal to 150,
n₁ and n₂ represent a number of ethylene oxide units of less than or equal to 150,
q₁ and q₂ represent a whole number at least equal to 1 and such that 0≦(m₁+n₁+p₁)q₁≦150 and 0≦(m₂+n₂+p₂)q₂≦150,
r represents a number such that 1≦r≦200,
R₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R₄, R₅, R₁₀ and R₁₁ represent hydrogen or the methyl or ethyl radical,
R₆, R₇, R₈ and R₉ represent linear or branched alkyl or aryl, or alkylaryl or arylalkyl groupings, having 1 to 20 carbon atoms, or their blends,
R₁₂ represents a hydrocarbonated radical having 1 to 40 carbon atoms,
A and B are groupings which may be present, which then represent a hydrocarbonated radical having 1 to 4 carbon atoms,
with formula (IIb)
R-A-Si(OB)₃
where:
R represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
A is a grouping which may be present, which then represents a hydrocarbonated radical having 1 to 4 carbon atoms,
B represents a hydrocarbonated radical having 1 to 4 carbon atoms,
or a blend of several of these monomers,
(d) 0% to 3% of at least one crosslinking monomer chosen from the group constituted by ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allyl ethers obtained from polyols such as pentaerythritol, sorbitol, sucrose or others, or chosen from among the molecules of formula (III): 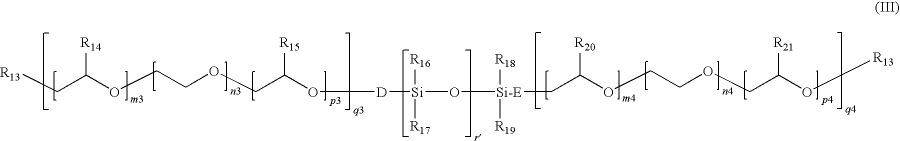
where:
m₃, p₃, m₄ and p₄ represent a number of alkylene oxide units of less than or equal to 150,
n₃ and n₄ represent a number of ethylene oxide units of less than or equal to 150,
q₃ and q₄ represent a whole number at least equal to 1 and such that 0≦(m₃+n₃+p₃)q₃≦150 and 0≦(m₄+n₄+p₄)q₄≦150,
r′ represents a number such that 1≦r′≦200,
R₁₃ represents a radical containing an unsaturated polymerisable function, preferentially belonging to the group of vinylics, or to the group of acrylic, methacrylic, maleic, itaconic, crotonic, vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉ represent linear or branched alkyl or aryl, or alkylaryl or arylalkyl groupings, having 1 to 20 carbon atoms, or their blends,
D and E are groupings which may be present, which then represent a hydrocarbonated radical having 1 to 4 carbon atoms,
or a blend of several of these monomers,
where the total proportions of the constituents a), b), c) and d) is equal to 100%.

12. A process according to claim 1, characterised in that the said comb polymer is obtained by processes of radical copolymerisation in solution, in a direct or reverse emulsion, in suspension or in precipitation in appropriate solvents, in the presence of known catalytic systems and transfer agents, or again by controlled radical polymerisation processes such as the method known as Reversible Addition Fragmentation Transfer (RAFT), the method known as Atom Transfer Radical Polymerization (ATRP), the method known as Nitroxide Mediated Polymerization (NMP) or again the method known as Cobaloxime Mediated Free Radical Polymerization.

13. A process according to claim 1, characterised in that the said comb polymer obtained in acid form and possibly distilled, may be partially or totally neutralised by one or more neutralisation agents having a monovalent neutralising function or a polyvalent neutralising function such as, for example, for the monovalent function, those chosen from the group constituted by the alkaline cations, in particular sodium, potassium, lithium, ammonium or the primary, secondary or tertiary aliphatic and/or cyclic amines, such as stearylamine, the ethanolamines (mono-, di-, triethanolamine), mono- and diethylamine, cyclohexylamine, methylcyclohexylamine, amino methyl propanol, morpholine, or again, for the polyvalent function, those chosen from the group constituted by the alkaline earth divalent cations, in particular magnesium and calcium, or again zinc, and also by the trivalent cations, in particular aluminium, or again by certain cations of higher valency.

14. A process according to claim 1, characterised in that the comb polymer derived from the polymerisation reaction may also be, before or after the total or partial neutralisation reaction, treated and separated into several phases, according to static or dynamic processes, by one or more polar solvents belonging notably to the group constituted by water, methanol, ethanol, propanol, isopropanol, the butanols, acetone, tetrahydrofuran or their blends.

15. A process according to claim 1, characterised in that the comb polymer is dried.

16. Paper coatings characterised in that they are obtained by the process according to claim 1.

17. (canceled)
